(19) United States
(12) Patent Application Publication
(10) Pub. No.: US 2011/0104026 A1
(43) Pub. Date: May 5, 2011

(54) APPARATUS FOR EXTRACTING BIOCHEMICAL MATERIALS FROM BIOLOGICAL SAMPLES

(76) Inventors: Seongjun YOON, Seoul (KR); Sanghyeon Kang, Seoul (KR); Jisung Park, Yongin-Si (KR); Bona Park, Sungnam-Si (KR); Mansoon Park, Yongin-Si (KR); Yoonhyeok Choi, Gwangju-Si (KR)

(21) Appl. No.: 12/683,113

(22) Filed: Jan. 6, 2010

(30) Foreign Application Priority Data
Nov. 5, 2009 (KR) 2009/0106266
Nov. 16, 2009 (KR) 2009/0110252

(51) Int. Cl. G01N 1/18

(52) U.S. Cl. 422/527; 422/536

(57) ABSTRACT

Disclosed herein is a single-use extraction apparatus which is disposed of after use. The extraction apparatus includes a tube plate having a tube therein, and a column plate. The column plate is detachably coupled to the tube plate, and includes a column which corresponds to the tube of the tube plate. A filter is provided in the column and made of a material which adsorbs or desorbs biochemical materials included in biological samples. A hollow suction port is provided at a predetermined position of the column plate to connect to a vacuum pump. The apparatus is capable of extracting biochemical materials from biological samples by using vacuum pressure without centrifugal separation, thus realizing a simple, convenient and rapid extracting operation, and has a small size so that it rapidly reaches desired vacuum pressure and uniform vacuum pressure can act on the column.

### CROSS REFERENCE TO RELATED APPLICATIONS

This application claims priority to Korean Patent Application No. 2009/0106266, filed Nov. 5, 2009, and to Korean Patent Application No. 2009/0110252, filed Nov. 16, 2009, which applications are incorporated by this reference in their entireties.

### BACKGROUND OF THE INVENTION

1. Field of the Invention

The present invention relates generally to an apparatus for extracting biochemical materials from biological samples and, more particularly, to a single-use extraction apparatus which is constructed to be disposed of after use and is used to extract and isolate biochemical materials such as DNA, RNA and protein from biological samples.

2. Description of the Related Art

Generally, in order to wash biochemical materials such as DNA, RNA and protein, extract the biochemical materials from biological samples, and purify the biochemical materials in a biological laboratory, cylindrical columns each having a component made of a material which can adsorb and desorb the biochemical materials are used.

As shown in FIG. 1, the conventional column 10 forms a set with a tube 20.

The column 10 includes a body 11 which has the shape of a cylindrical tube, an outlet port 12 which protrudes from the lower end of the body 11 and has a diameter smaller than that of the body 11, and a lid 13 which is provided on the upper end of the body 11 to open or close off the body 11. Further, a filter 14 having a plurality of filter membranes for adsorbing or desorbing biochemical materials is installed in the lower end of the body 11 of the column 10. Such a filter 14 is not used for the purpose of general filtration but is used for the specific adsorption and desorption of biochemical materials. Thus, the filter 14 is only one utilizable form, and may be in the form of silica gel, fine powder or beads. Hereinafter, all of the forms are referred to as a “filter”.

Further, the tube 20 has the shape of a cylindrical tube which has a diameter bigger than that of the column 10. The outlet port 12 of the column 10 and one end of the body 11 are inserted into the tube 20. In such a state, a washing solution of biological samples or a solution containing biochemical materials is discharged from the column 10 to the tube 20 by the centrifugal force created in a device such as a centrifugal separator (hereinafter, referred to as the “centrifugal separator”).

That is, after the column 10 is inserted into the tube 20, the biological samples containing the biochemical materials such as DNA, RNA and protein are supplied into the body 11 of the column 10, and the washing solution is supplied to remove undesirable biochemical materials or contaminating components which are included in the supplied biological samples but are to be removed. Thereafter, the tube 20 into which the column 10 is inserted is installed in the centrifugal separator (not shown) and is rotated at high speed, so that the washing solution containing impurities (biochemical materials which are to be removed or other contaminating components) except for biochemical materials which are to be extracted passes through the filter 14 and is discharged into the tube 20 by centrifugal force generated as the result of the high-speed rotation. Since the washing solution containing the impurities collected in the tube 20 is not needed in subsequent work, the tube 20 and the column 10 are disassembled and the washing solution is dumped out. After the washing solution has been dumped out, the tube 20 is coupled to the column 10 again.

Such a process is generally repeated several times so that undesirable materials can be removed from the biological samples, thus enhancing the purity of the desired biochemical materials in the solution which is finally obtained and in which the biochemical materials are contained; thus, the process is designated as a washing process. During the washing process, the desired biochemical materials are adsorbed on the filter 14 which is installed in the column 10, and other undesirable materials are eluted by the washing solution. After the washing process has been completed, the desired biochemical materials which were adsorbed on the filter 14 are recovered. For the recovery of the desired biochemical materials, an elution solution is put into the column 10. Thereafter, the elution solution containing the desired biochemical materials is discharged into the tube 20 using the centrifugal separator.

However, the conventional sample extracting method is problematic in that a worker must repeat the above-mentioned process several times during entire washing process, and the centrifugal separator must be used whenever the each process of entire washing process is performed. When the centrifugal separator is used, a predetermined centrifugal force must be generated to discharge the solution from the column 10 mounted to the centrifugal separator. This is achieved by the rotation of a rotor which is installed in the centrifugal separator. In order to generate a predetermined centrifugal force, a predetermined speed of rotation of the rotor is inevitably required. As such, in order to increase the rotating speed of the rotor to a predetermined speed, an acceleration period is necessary and acceleration is routinely executed slowly due to the mechanical restrictions. Meanwhile, after the centrifugal separation has been performed for a predetermined period of time as set by a worker, the rotation must be stopped to detach the column 10 from the centrifugal separator. Here, the rotation must not be stopped rapidly but must be stopped slowly. Since the acceleration and stopping are slowly executed, the net time required to use the centrifugal separator is much longer than the time required to actually perform centrifugal separation. Thus, the conventional method of using the centrifugal separator lengthens the net working time because it takes a long time to perform the centrifugal separation process. It is not necessary to delve into the inconvenience and inefficiency caused by the long working period. Particularly, in dealing with multiple samples, this becomes a serious problem.

In order to overcome the drawbacks caused by the use of the centrifugal separator, a vacuum manifold 30 is developed to isolate desired biochemical materials from biological samples using vacuum pressure. The vacuum manifold 30 is proposed to substitute for the centrifugal separator in the conventional method wherein only the centrifugal separator is used. Columns 10 and a vacuum pump are mounted to the vacuum manifold 30.

FIG. 2 illustrates the conventional vacuum manifold. The vacuum manifold has the shape of a sealed box. Mounting holes 31 are perforated through the upper surface of the vacuum manifold 30 so that the outlet port 12 of each column 10 is inserted into and mounted to the corresponding mounting hole 31. A suction port 32 is provided on one side of the vacuum manifold 30 and connected to the vacuum pump (not shown) to draw internal air from the vacuum manifold 30 and discharge the internal air to the outside, thus creating a vacuum inside of the vacuum manifold 30, therefore allowing the vacuum pressure to act on the columns 10. A drain port 33 is provided on the other side of the vacuum manifold 30 to discharge a solution out of the vacuum manifold 30. Preferably, a valve (not shown) or a stopper (not shown) is additionally installed in the drain port 33 to open or close the drain port 33.

Meanwhile, after the outlet port 12 of each column 10 is inserted into the corresponding mounting hole 31 formed in the upper surface of the vacuum manifold 30, air is drawn from inside of the vacuum manifold 30 by the vacuum pump connected through the suction port 32. In this case, as the internal pressure of the vacuum manifold 30 is lowered, negative pressure (hereinafter, referred to as “vacuum pressure”) is formed, and the solution in the column 10 is discharged into the vacuum manifold 30 by the vacuum pressure. When the washing solution is applied to the column 10, the washing solution containing impurities (biochemical materials which are to be removed or contaminating components) is discharged into inside of the vacuum manifold 30.

The conventional method of using the vacuum manifold 30 puts an elution solution into the column 10 to elute desired biochemical materials as a final process, and thereafter, performs centrifugal separation in a manner similar to the former conventional method wherein the centrifugal separator should be used. The reason why the centrifugal separation must be performed in the final process is because the vacuum manifold 30 is repeatedly used, so that the vacuum manifold 30 is contaminated by several types of material. Further, since the solutions discharged from respective columns 10 are pooled, it is impossible to separately recover only the solution discharged from an associated column 10 containing only the desired biochemical materials.

Therefore, the centrifugal separation performed in the final process renders the work inconvenient and complicated, as in the conventional method wherein the centrifugal separator is used.

Further, the conventional vacuum manifold 30 has many mounting holes 31 so that a plurality of columns 10 is mounted to the upper surface of the vacuum manifold 30. In order to form the many mounting holes 31, the size of the vacuum manifold 30 must be increased. In the case of the large vacuum manifold 30, it takes a long time to create the desired vacuum pressure in the vacuum manifold 30, so that a waiting time required until vacuum pressure is formed whenever each operation including washing operations is performed is increased, and the entire working time is lengthened, thus causing inconvenience. Further, it is difficult to apply uniform vacuum pressure to the columns 10 mounted to the respective mounting holes 31.

Even though the conventional extracting method using the vacuum manifold 30 does not reuse the columns 10, the vacuum manifold 30 itself must be reused, so that there is possibility of cross contamination between the extracting operations, and the cross contamination between the extracting operations may cause an erroneous result in subsequent work which uses the extracted biochemical materials.

### SUMMARY OF THE INVENTION

Accordingly, the present invention has been made keeping in mind the above problems occurring in the prior art, and an object of the present invention is to provide an apparatus for extracting biochemical materials from biological samples, which has small size and a disposable single-use structure and selectively extracts biochemical materials such as DNA, RNA and protein from biological samples using a vacuum extraction method, so that the apparatus does not use a centrifugal separator, thus allowing biochemical materials to be simply, conveniently and rapidly extracted from biological samples, enabling the desired vacuum pressure to be rapidly created and applying uniform vacuum pressure to act on columns owing to the small size, and which is not reused unlike a conventional extraction apparatus, thus preventing cross contamination between extracting operations which may result from the repeated use of one extraction apparatus in several operations.

In order to accomplish the above object, the present invention provides an apparatus for extracting biochemical materials from biological samples, including a column plate having therein at least one column into which the biological samples are loaded, with a filter provided in the column, and a tube plate detachably coupled to the column plate and having therein at least one tube which corresponds to the column of the column plate, so that a solution containing biochemical materials which are to be extracted from the biological samples loaded into the column is discharged and stored in the tube by vacuum pressure.

Further, in order to accomplish the above object, the present invention provides an apparatus for extracting biochemical materials from biological samples, including a column plate having therein at least one column into which the biological samples are loaded, with a filter provided in the column, a reservoir plate detachably coupled to the column plate and storing a washing solution discharged from the biological samples loaded into the column by vacuum pressure, and a tube plate detachably coupled to the column plate and having therein at least one tube which corresponds to the column of the column plate, so that a solution containing biochemical materials which are to be extracted from the biological samples loaded into the column is discharged and stored in the tube by vacuum pressure.

Further, a cover slip made of a pliable material may be detachably coupled to the column of the column plate to open or close the column, and a groove may be formed in the cover slip to allow the cover slip to be in closer contact with the column when vacuum pressure acts on the column.

A lower end of the column may be positioned in the tube when the column plate and the tube plate are coupled to each other. The tube of the tube plate may have a cut part to discharge a solution out of the tube when the tube is filled with the discharged solution to a predetermined height, and the cut part may be arranged such that it does not face a cut part of an adjacent tube. The tube plate may include at a predetermined position thereof a coupling marking part, and the column plate may include at a predetermined position thereof a coupling marking part to correspond to the coupling marking part of the tube plate.

Further, a supporter may protrude from an outer surface of the tube plate to support the column plate which is coupled to the tube plate. The bottom of the tube of the tube plate may be gently inclined.

The reservoir plate may include at a predetermined position thereof a coupling marking part, and the column plate may include at a predetermined position thereof a coupling marking part to correspond to the coupling marking part of the reservoir plate. A supporter may protrude from an outer surface of the reservoir plate to support the column plate which is coupled to the reservoir plate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating a typical column and tube for extracting biochemical materials from biological samples;

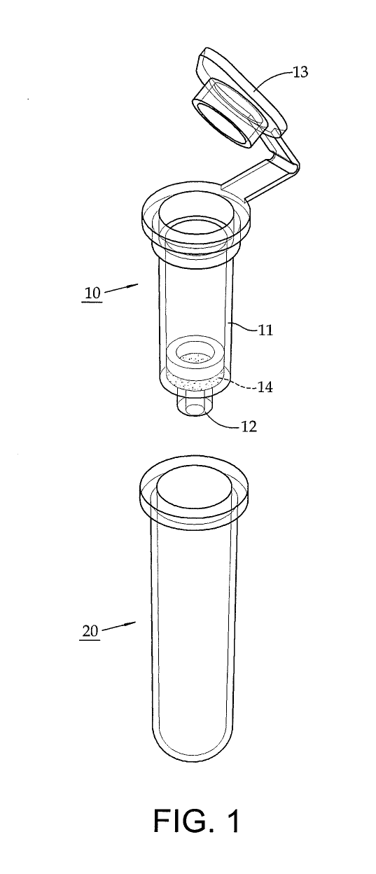

FIG. 2 is a sectional view illustrating a conventional vacuum manifold equipped with typical columns;

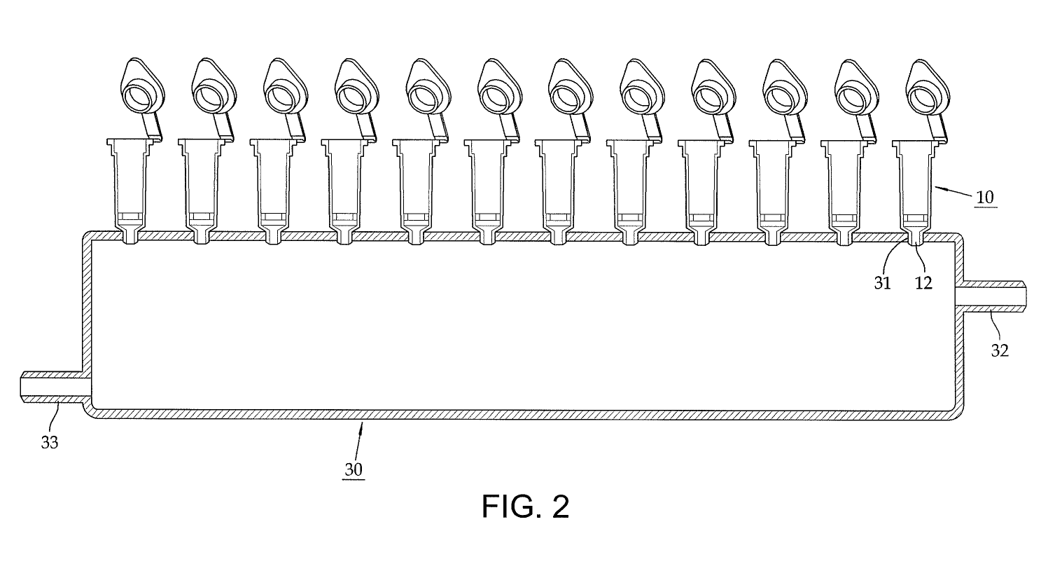

FIG. 3 is an exploded perspective view illustrating a single-use apparatus for extracting biochemical materials from biological samples according to a first embodiment of the present invention;

FIG. 4 is a perspective view illustrating the single-use apparatus for extracting biochemical materials from biological samples according to the first embodiment of the present invention;

FIG. 5 is an exploded sectional view illustrating the single-use apparatus for extracting biochemical materials from biological samples according to the first embodiment of the present invention;

FIGS. 6A and 6B are views illustrating a process of extracting biochemical materials using the single-use apparatus for extracting biochemical materials from biological samples according to the first embodiment of the present invention;

FIG. 7 is a view illustrating the example wherein a plurality of single-use extraction apparatuses according to the present invention is used simultaneously;

FIG. 8 is an exploded perspective view illustrating a single-use apparatus for extracting biochemical materials from biological samples according to a second embodiment of the present invention; and

FIG. 9 is an exploded perspective view illustrating a single-use apparatus for extracting biochemical materials from biological samples according to a third embodiment of the present invention.

### DESCRIPTION OF THE PREFERRED EMBODIMENTS

Hereinafter, the preferred embodiments of the present invention will be described in detail with reference to the accompanying drawings.

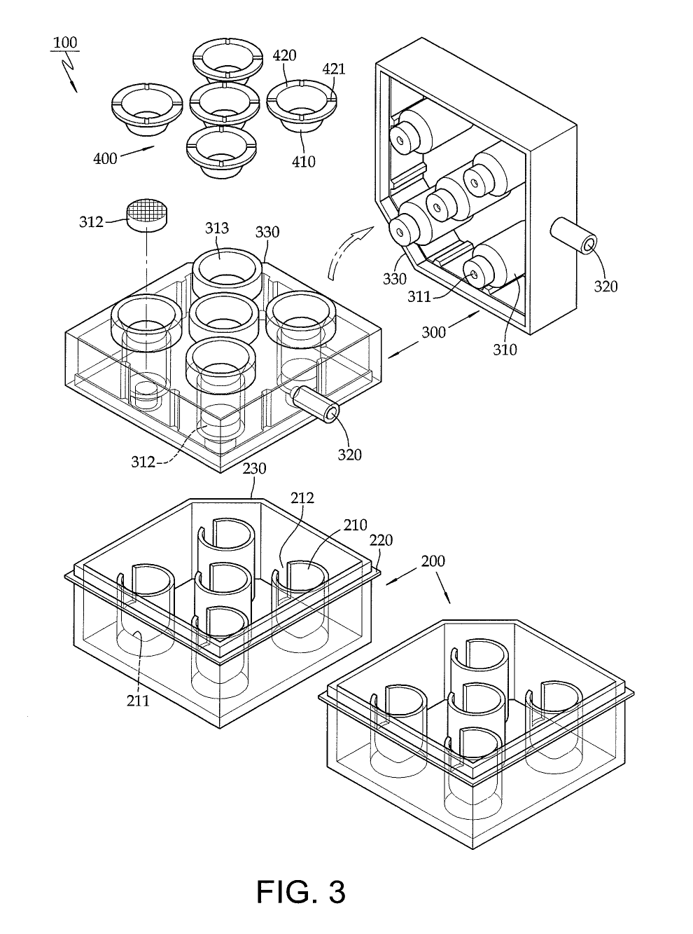

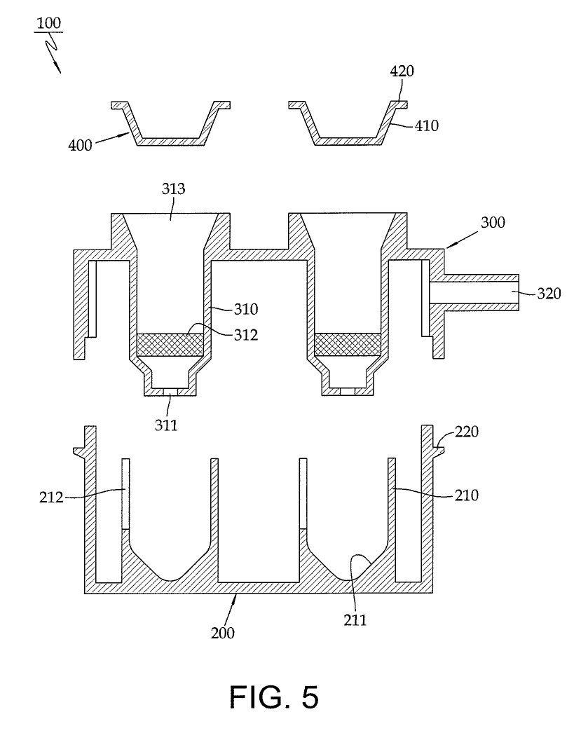

FIGS. 3 through 9 are of views illustrating an apparatus for extracting biochemical materials from biological samples according to the present invention.

As shown in FIGS. 3 to 5, an extraction apparatus 100 of the present invention includes two tube plates 200, a column plate 300, and cover slips 400.

Each tube plate 200 has the shape of a small rectangular box which is open at its top. A plurality of tubes 210 protrudes integrally from the bottom of the tube plate 200, and a solution discharged from a column 310 that will be described below is collected into the corresponding tube 210.

The tube 210 is a hollow tube which is open at its top. Ten or fewer tubes protrude from the tube plate 200. More preferably, five tubes protrude from the tube plate 200. The bottom of the interior of the tube 210 comprises a gently inclined surface 211, thus allowing the solution discharged into the tube 210 to be easily and maximally collected.

Further, a cut part 212 is formed in a predetermined portion of each tube 210 in such a way as to be cut in the longitudinal direction of the tube 210, that is, in a vertical direction. Thus, when a washing solution containing impurities fills the tube 210 to a predetermined height, the washing solution naturally runs over to the tube plate 200 outside the tube 210, thus preventing the washing solution containing impurities from being in direct contact with the column 310 which will be described below, therefore preventing the contamination of samples.

Preferably, the cut parts 212 of the tubes 210 are arranged such that they do not face each other. Such an arrangement prevents the solution discharged from a tube 210 to the tube plate 200 from flowing into another adjacent tube 210 again.

Further, a supporter 220 protrudes from the outer surface of the tube plate 200 to support the column plate 300 which is coupled to the tube plate 200. The supporter 220 is formed throughout the outer surface of the tube plate 200 in such a way as to protrude, thus effectively creating vacuum pressure.

A coupling marking part 230 is provided at a predetermined position on the outer surface of the tube plate 200 to guide correct coupling of the tube plate 200 with the column plate 300. The coupling marking part 230 is formed by beveling one of four corners of the tube plate 200.

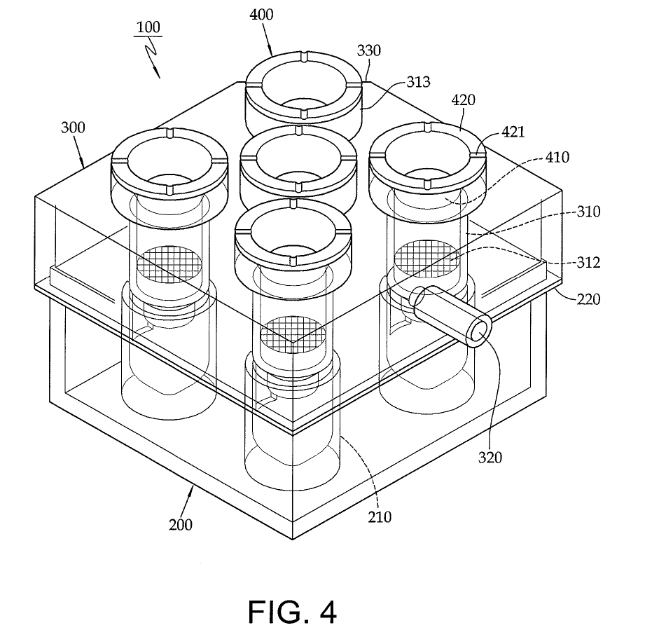

Thus, the tube plate 200 and the column plate 300 are always coupled to each other only in a predetermined direction by the coupling marking part 230, as shown in FIG. 4. As such, the coupling having a predetermined directivity allows each column 310 of the column plate 300 to be precisely inserted into the corresponding tube 210 of the tube plate 200 while one column 310 and one tube 210 always form a pair.

Meanwhile, two tube plates 200 constructed as described above constitute one set. One tube plate 200 is used to collect a washing solution containing impurities, whereas the other tube plate 200 is used to collect a solution containing the desired biochemical materials. Since the tube plates 200 are used once and are not reused, cross contamination is prevented between extracting operations.

Since the two tube plates 200 have the same construction and structure, they will carry the same reference numerals.

The column plate 300 has the shape of a small rectangular box to correspond to the tube plate 200, and is open at its bottom. Ten or fewer columns 310, more preferably, five columns 310 protrude from the ceiling of the interior of the column plate 300 to correspond to the tubes 210.

Each column 310 is a container into which biological samples containing biochemical materials such as DNA, RNA and protein are loaded. An input port 313 is provided on the upper end of the column 310 to pass through the column plate 300, and an outlet port 311 is provided on the lower end of the column 310 in such a way that a diameter gradually reduces. A filter 312 comprising a plurality of filter membranes is installed in the column 310 to adsorb and desorb biochemical materials.

As described above, the filter 312 is not used for the purpose of general filtration, but is used for the specific adsorption and desorption of biochemical materials. Thus, the filter 312 constructed as described above is only one embodiment of the present invention, and may be realized in the form of silica gel, fine powder or beads. It is to be understood that the term “filter” includes all of these varieties.

Although not shown in the drawings of this embodiment, preferably, a grid-type support is installed on the lower surface of the filter 312 so that the filter 312 is not bent towards the outlet port 311 of the column 310 and does not sag because of vacuum pressure acting on the column 310, and a support ring in the form of an O-ring is installed to the upper surface of the filter 312 to prevent the undesirable movement or removal of the filter 312.

Meanwhile, when the column plate 300 and the tube plate 200 are coupled to each other, the outlet port 311 of the column 310 is inserted into the tube 210. Through such a coupling manner of the column 310 with the tube 210, the solution discharged from the column 310 is not discharged to the outside of the tube 210 but all of the solution is fed precisely into the tube 210.

Further, a suction port 320 protrudes from the outer surface of the column plate 300. A vacuum pump is connected to the suction port 320 to draw air from a space formed by coupling the tube plate 200 with the column plate 300, thus creating a vacuum in the space formed between the tube plate 200 and the column plate 300 of the extraction apparatus 100. Meanwhile, as one example of this embodiment, the suction port 320 is formed on the column plate 300. However, the suction port 320 may be formed on the outer surface of the tube plate 200.

Further, a coupling marking part 330 is provided on the column plate 300 to correspond to the coupling marking part 230 of the tube plate 200, thus guiding the coupling of the tube plate 200 with the column plate 300 in the correct direction.

That is, when the tube plate 200 is coupled with the column plate 300, both the coupling marking parts 230 and 330 allow the tube plate 200 and the column plate 300 to always be coupled with each other only in a predetermined direction. Thus, the outlet port 311 of the column 310 is precisely inserted into the tube 210 paired with the column 310.

The tube plate 200 and the column plate 300 are generally manufactured through injection molding. Here, the tubes 210 of the tube plate 200 and the columns 310 of the column plate 300 are formed to have a one-to-one correspondence. The coupling of the corresponding tubes 210 and columns 310 is precisely achieved using the coupling marking parts 230 and 330.

Further, the cover slip 400 is installed in the input port 313 of each column 310 to seal the column 310, thus improving the vacuum level of the column 310.

The cover slip 400 is a thin membrane which is made of a pliable material. The cover slip 400 includes a protruding stopper 410 and a flange 420. The stopper 410 is directly inserted into the input port 313 to open or close the input port 313. The flange 420 protrudes outwards from the outer circumference of the stopper 410 to be seated on the upper surface of the input port 313.

A plurality of grooves 421 is formed in the flange 420 and contracts when vacuum is created in the column 310 to allow the flange 420 to be in closer contact with the upper surface of the input port 313, thus increasing sealability.

Meanwhile, the tube plate 200 has 10 or fewer tubes 210 and the column plate 300 has 10 or fewer columns 310 to correspond to the tubes 210, thus providing the small-scale extraction apparatus. Thus, when vacuum pressure acts on the columns 310, uniform vacuum pressure can be applied to all of the columns 310.

Further, several extraction apparatuses 100 each having the tube plates 200 and the column plate 300 may be coupled to each other as desired such that the several extraction apparatuses 100 may be used simultaneously.

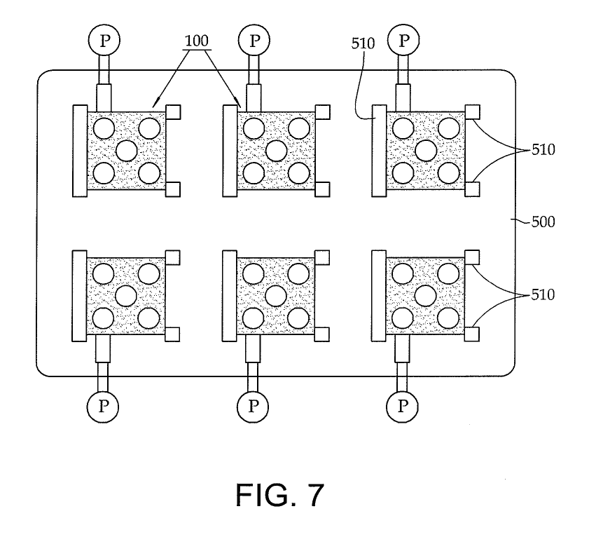

That is, as shown in FIG. 7, in order to simultaneously use the plurality of extraction apparatuses 100 each having the tube plates 200 and the column plate 300, each of the extraction apparatuses 100 must be installed in a multiple plate 500. A plurality of locking blocks 510 is provided on the multiple plate 500 to detachably install each extraction apparatus 100 to the multiple plate 500.

As shown in FIG. 7, one vacuum pump may be individually connected to the suction port 320 of each of the extraction apparatuses 100 installed in the multiple plate 500 through the locking blocks 510, so that vacuum pressure may be individually applied to each extraction apparatus 100. Alternatively, the extraction apparatuses 100 may be connected to one vacuum pump using one pipe or tube, so that vacuum pressure may be simultaneously applied to the extraction apparatuses 100.

The process of extracting biochemical materials from biological samples, using the extraction apparatus of the present invention which is constructed as described above, will be described below.

First, when the coupling marking part 330 of the column plate 300 is aligned with the coupling marking part 230 of the tube plate 200, the column plate 300 is coupled to the tube plate 200. Here, the column plate 300 is seated and supported on the supporter 220 of the tube plate 200.

Before the column plate 300 is mounted to the tube plate 200, biological samples containing biochemical materials such as DNA, RNA and protein may be loaded into each column 310 of the column plate 300. Alternatively, as described above, after the column plate 300 is coupled to the tube plate 200, biological samples containing biochemical materials such as DNA, RNA and protein may be loaded into each column 310 of the column plate 300.

Of course, after the biological samples are put into each column 310, the input port 313 of the column 310 is covered by the cover slip 400, thus sealing the column 310.

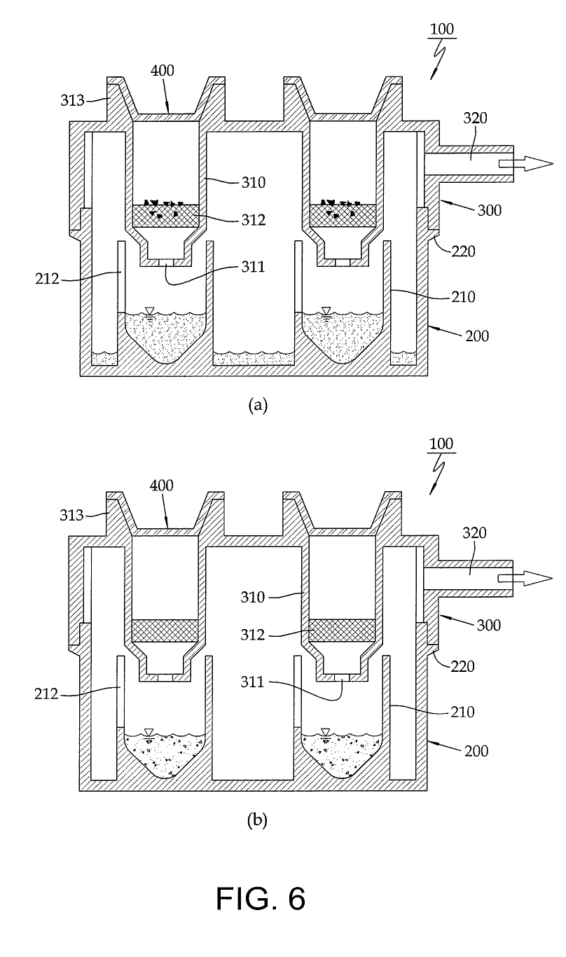

Subsequently, the vacuum pump connected to the suction port 320 of the column plate 300 sucks air which is present in the internal space formed by coupling the column plate 300 with the tube plate 200, and discharges the air to the outside. Thus, as shown in FIG. 6A, vacuum is created in the internal space, so that the vacuum pressure acts on the interior of the column 310 through the outlet port 311 of the column 310, thus discharging a solution (washing solution) from the interior of the column 310 through the filter 312 into the tube 210.

Here, each of the tube plates 200 and the column plate 300 is manufactured to have a small size, thus rapidly reaching desired vacuum pressure and allowing uniform vacuum pressure to act on each column 310.

Further, since the outlet port 311 of each column 310 is inserted into the upper portion of the corresponding tube 210, the discharged solution is not dispersed to the tube plate 200 and is collected and stored in each tube 210 paired with each column 310. Further, if the solution stored in the tube 210 reaches a predetermined height, the solution runs over to the tube plate 200 outside the tube 210 through the cut part 212 of the tube 210, thus preventing the solution in the tube 210 from being in direct contact with the outlet port 311 of the corresponding column 310.

Next, after the tube plate 200 containing the discharged solution and the column plate 300 are disassembled, and another tube plate 200 is coupled to the column plate 300 again, a vacuum is created in a space between the tube plate 200 and the column plate 300.

At this time, an elution solution for extracting samples is supplied to each column 310, and a solution containing desired biochemical materials is discharged into each tube 210 by vacuum pressure acting on the interior of the tube 210, as shown in FIG. 6B. As such, the solution containing the biological samples discharged to each tube 210 is drawn out using an instrument such as a pipette.

Further, since the bottom of each tube 210 is the gently inclined surface 211, the solution in the tube 210 converges on the central portion of the bottom of the tube 210. Hence, even the final solution remaining in the tube 210 may be easily collected.

Thus, according to the present invention, when desired biochemical materials are extracted from the biological samples, a centrifugal separation operation can be completely eliminated unlike the related art. Moreover, the present invention provides a simple structure, in addition to simplifying the work process and shortening the work period.

Further, the present invention completely eliminates the centrifugal separation operation. Thus, the size of the column is not limited by a standardized centrifugal separator but is variable as desired, so that the yield of desired biochemical materials can be increased.

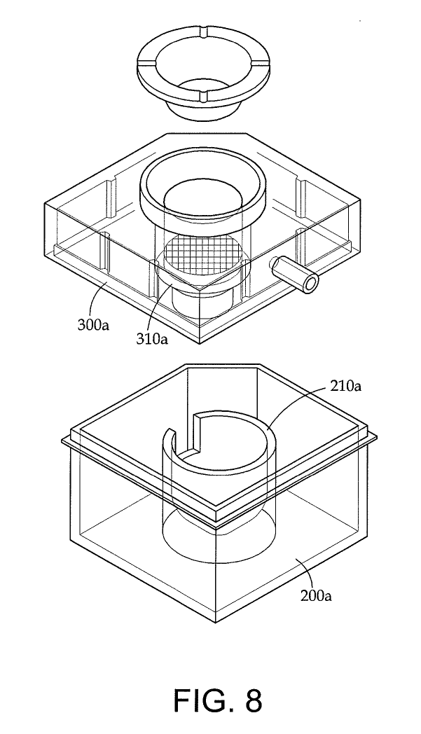

Meanwhile, FIG. 8 is an exploded perspective view illustrating a single-use apparatus for extracting biochemical materials from biological samples according to another embodiment of the present invention. The same reference numerals are used throughout both the embodiments to designate the same components, and a duplicate description will be omitted herein.

As shown in FIG. 8, according to this embodiment, a tube plate 200a has one tube 210a and a column plate 300a has one column 310a.

As such, one tube 210a formed on the tube plate 200a and one column 310a formed on the column plate 300a may be formed to be larger than each tube 210 of the tube plate 200 and each column 310 of the column plate 300 according to the above-mentioned embodiment, thus increasing the yield of desired biochemical materials.

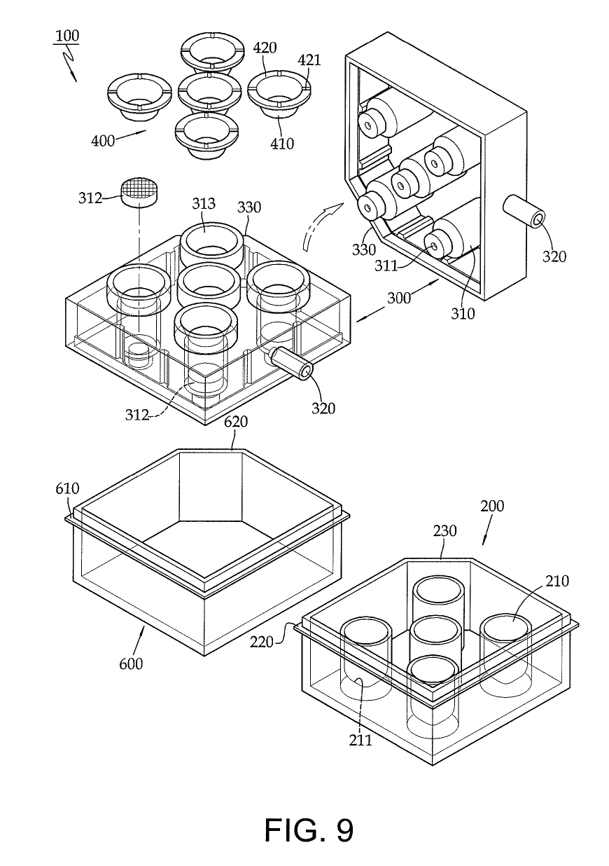

Further, FIG. 9 is a view illustrating a single-use apparatus for extracting biochemical materials from biological samples according to a further embodiment of the present invention. Components which are identical with those of the above-mentioned embodiments will carry the same reference numerals, and the description which would be repetitive will be omitted.

As shown in FIG. 9, the extraction apparatus 100 of this embodiment includes one column plate 300, one reservoir plate 600, one tube plate 200, and cover slips 400.

Here, since the column plate 300, the tube plate 200, and the cover slips 400 are equal to those of the above-mentioned embodiments, a repetitive description will be omitted herein.

The reservoir plate 600 has the shape of a box which is open at its top, and collects and stores the washing solution which is discharged from biological samples loaded in the columns 310 of the column plate 300 using vacuum pressure.

Such a reservoir plate 600 comprises an empty space having no tube, unlike the tube plate 200. A coupling marking part 620 is provided at a predetermined position on the outer surface of the reservoir plate 600 to correspond to the coupling marking part 330 of the column plate 300. The coupling marking part 620 is formed by beveling one of four corners of the reservoir plate 600.

Further, a supporter 610 protrudes from the outer surface of the reservoir plate 600 to support the column plate 300 which is coupled to the reservoir plate 600. The supporter 610 is formed throughout the whole outer surface of the reservoir plate 600 in such a way as to protrude, thus effectively applying vacuum pressure.

Thus, the reservoir plate 600 constructed as such is coupled with the column plate 300, so that the washing solution discharged from the column 310 through the filter 312 by vacuum pressure is collected and stored in the reservoir plate 600. When the reservoir plate 600 is manufactured, unnecessary construction such as the tubes 210 is omitted beforehand, so that manufacturing cost and productivity are improved.

Further, each tube 210 of the tube plate 200 according to this embodiment has no cut part as shown in FIG. 9. However, the tube 210 may have a cut part as in the embodiment shown in FIG. 3.

As described above, the present invention provides an apparatus for extracting biochemical materials from biological samples, which includes two tube plates or one reservoir plate and one tube plate, and one column plate to perform both washing and isolation operations of desired biochemical materials, thus allowing biochemical materials which are to be used as samples in a subsequent operation to be simply, conveniently and rapidly extracted from biological samples to a tube without using a centrifugal separator.

Further, the present invention provides an apparatus for extracting biochemical materials from biological samples, in which a tube plate or a reservoir plate collecting a primary solution (washing solution) is dumped, and another tube plate collecting secondary solution containing desired biochemical materials is not repeatedly used, thus preventing cross contamination from occurring between extracting operations.

Furthermore, the present invention provides an apparatus for extracting biochemical materials from biological samples, in which 10 or fewer tubes are provided in a tube plate and 10 or fewer columns are provided in a column plate to realize a small size, so that a space in which a vacuum is to be created is small, thus allowing the desired vacuum pressure to be rapidly obtained, in addition to applying uniform vacuum pressure to each column of the column plate.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for extracting biochemical materials from biological samples, comprising:
a plurality of tube plates each having at least one tube therein; and
a column plate detachably coupled to each of the tube plates, and including:
at least one column provided in the column plate to correspond to the tube of the tube plate, with a filter being provided in the column; and
a suction port provided at a predetermined position of the column plate to create a vacuum.

2. The apparatus as set forth in claim 1, wherein a cover slip made of a pliable material is detachably coupled to the column of the column plate to open or close the column.

3. The apparatus as set forth in claim 2, wherein the cover slip comprises a groove to allow the cover slip to be in closer contact with the column when vacuum pressure acts on the column.

4. The apparatus as set forth in claim 1, wherein a lower end of the column is positioned in the tube when the column plate and each of the tube plates are coupled to each other.

5. The apparatus as set forth in claim 1, wherein the tube of each of the tube plates comprises a cut part to discharge a solution out of the tube when the tube is filled with the solution discharged from the column, the cut part being arranged such that it does not face a cut part of an adjacent tube.

6. The apparatus as set forth in claim 1, wherein each of the tube plates comprises at a predetermined position thereof a coupling marking part, and the column plate comprises at a predetermined position thereof a coupling marking part to correspond to the coupling marking part of the tube plate.

7. The apparatus as set forth in claim 1, wherein a supporter protrudes from an outer surface of each of the tube plates to support the column plate which is coupled to the tube plate.

8. The apparatus as set forth in claim 1, wherein a bottom of the tube of each of the tube plates is gently inclined.

9. An apparatus for extracting biochemical materials from biological samples, comprising:
a column plate having therein at least one column into which the biological samples are loaded, with a filter provided in the column; and
a plurality of tube plates detachably coupled to the column plate and having therein at least one tube which corresponds to the column of the column plate, so that a solution containing biochemical materials which are to be extracted from the biological samples loaded into the column is collected and stored in the tube by vacuum pressure.

10. An apparatus for extracting biochemical materials from biological samples, comprising:
a column plate having therein at least one column into which the biological samples are loaded, with a filter provided in the column;
a reservoir plate detachably coupled to the column plate, and storing a washing solution discharged from the biological samples loaded into the column by vacuum pressure; and
a tube plate detachably coupled to the column plate and having therein at least one tube which corresponds to the column of the column plate, so that a solution containing biochemical materials which are to be extracted from the biological samples loaded into the column is collected and stored in the tube by vacuum pressure.

11. The apparatus as set forth in claim 9, wherein a cover slip made of a pliable material is detachably coupled to the column of the column plate to open or close the column.

12. The apparatus as set forth in claim 11, wherein a groove is formed in the cover slip to allow the cover slip to be in closer contact with the column when vacuum pressure acts on the column.

13. The apparatus as set forth in claim 9, wherein a lower end of the column is positioned in the tube when the column plate and the tube plate are coupled to each other.

14. The apparatus as set forth in claim 9, wherein the tube of the tube plate comprises a cut part to discharge a solution out of the tube when the tube is filled with the solution discharged from the column, the cut part being arranged such that it does not face a cut part of an adjacent tube.

15. The apparatus as set forth in claim 9, wherein the tube plate comprises at a predetermined position thereof a coupling marking part, and the column plate comprises at a predetermined position thereof a coupling marking part to correspond to the coupling marking part of the tube plate.

16. The apparatus as set forth in claim 9, wherein a supporter protrudes from an outer surface of the tube plate to support the column plate which is coupled to the tube plate.

17. The apparatus as set forth in claim 9, wherein a bottom of the tube of the tube plate is gently inclined.

18. The apparatus as set forth in claim 10, wherein the reservoir plate comprises at a predetermined position thereof a coupling marking part, and the column plate comprises at a predetermined position thereof a coupling marking part to correspond to the coupling marking part of the reservoir plate.

19. The apparatus as set forth in claim 10, wherein a supporter protrudes from an outer surface of the reservoir plate to support the column plate which is coupled to the reservoir plate.

20. The apparatus as set forth in claim 10, wherein a cover slip made of a pliable material is detachably coupled to the column of the column plate to open or close the column.

21. The apparatus as set forth in claim 10, wherein a lower end of the column is positioned in the tube when the column plate and the tube plate are coupled to each other.

22. The apparatus as set forth in claim 10, wherein the tube of the tube plate comprises a cut part to discharge a solution out of the tube when the tube is filled with the solution discharged from the column, the cut part being arranged such that it does not face a cut part of an adjacent tube.

23. The apparatus as set forth in claim 10, wherein the tube plate comprises at a predetermined position thereof a coupling marking part, and the column plate comprises at a predetermined position thereof a coupling marking part to correspond to the coupling marking part of the tube plate.

24. The apparatus as set forth in claim 10, wherein a supporter protrudes from an outer surface of the tube plate to support the column plate which is coupled to the tube plate.

25. The apparatus as set forth in claim 10, wherein a bottom of the tube of the tube plate is gently inclined.
